(19) United States
(12) Patent Application Publication
(10) Pub. No.: US 2014/0356062 A1
(43) Pub. Date: Dec. 4, 2014

(54) SECURITIZED ASSEMBLY OF TWO PIECES VIA SCREWING PROCESS

(71) Applicant: ZF SYSTEMES DE DIRECTION NACAM S.A.S, Vendome (FR)

(72) Inventors: Arnaud JANVIER, Saint Leonerd En Beauce (FR); Gilles DUBOUILH, Castelnau Sur Gupie (FR); Frédie GOUGE, Sainte Anne (FR)

(73) Assignee: ZF SYSTEMES DE DIRECTION NACAM S.A.S, Vendome (FR)

(21) Appl. No.: 14/290,414

(22) Filed: May 29, 2014

Related U.S. Application Data
(60) Provisional application No. 61/837,518, filed on Jun. 20, 2013.

(30) Foreign Application Priority Data
May 29, 2013 (FR) 1354892

(51) Int. Cl. F16D 1/076

(52) U.S. Cl. CPC F16D 1/076
USPC 403/374.3

(57) ABSTRACT

This invention relates to a device for fastening comprising a jaw, a screw with a diameter d and a shaft, the jaw having two parallel flanks surrounding a portion of the shaft, with the shaft having a peripheral recess in line with the screw in assembled position and with each of the flanks having an orifice that the screw passes through, it is characterised in that one of the orifices is of oblong shape. The oblong shape of the orifice makes it possible to prevent the screw from becoming “stuck” between the shaft and the orifice when the shaft is incorrectly positioned, by releasing the screw as soon as the latter enters into interference with another part or an obstacle and as such makes it possible to prevent the transmission of a torque between the two parts to be attached.

This invention relates to a device for the secured fastening of two parts by screwing and in particular those of steering columns. The steering columns include the components between the steering wheel and the wheels, which are in order: the steering wheel, the steering column, the intermediate shaft, the rack and finally the wheels. The fastening that is of interest here is that of the intermediate shaft between the shaft of the steering column and the shaft of the rack. The intermediate shaft is constituted, of two cardan joints connected together by a shaft, with each cardan joint being constituted of two jaws provided with two flanks, one being linked to the shaft and the other able to accept different forms which are complementary either with the shaft of the steering column or with the shaft of the rack and which will receive the assembly screw.

There are many devices to secure screwed connections.

The first principle is the use of an additional part in order to prevent the assembly of the screw as long as the shaft and the jaw are not perfectly aligned.

The second principle is the use of a special screw that makes possible the assembly once the two parts are perfectly aligned.

And finally the third principle incorporates a counter-bore in the flanks in order to prevent the transmission of the torque by deformation of the flank when the shaft is partially engaged but still in the axis of the column or the axis of the shaft of the rack.

The existing devices do not secure all of the cases of incorrect connections between two parts.

For all of these screwed connections, the securing of the axial connection of the system is accomplished using a groove of a suitable shape on the shaft of the steering column or of the shaft of the rack wherein the screw is positioned during a good mounting and as such prevents any axial escaping in the event of insufficient tightening of the screw.

When the axis of the shaft of the column or the shaft of the rack and the flank are not facing each other or when one of the parts is not perfectly engaged, it may be the case that the screw can be mounted manually. In the case where the pitch of the thread of the screw is close to the pitch of the grooves of the shaft there can be a “false screwing” of the screw although it is thought that the screw has reached the other orifice of the flank.

The tool for assisting in assembling screws is often used in order to guarantee the correct screwing of the screw by measuring the angle and the screwing torque and by comparing it with the recommended values. This is particularly true in the case of safety connections subjected to severe and repeated fatigue stresses. In the case of partially secured designs, as described hereinabove, it is possible to have a screwing under torque with deformation and/or machining of the flank and/or of the shaft able to give the illusion that the connection has been carried out correctly as the screwing tool measures the values close to those that it would have measured in the case of a connection correctly carried out.

There is then the illusion of a proper screwing although the two parts are not correctly positioned, which can result in breakage or accidents.

The object of this invention is to propose a fastening that is both simple and secure.

The device for fastening according to the invention comprises a jaw, a screw with a diameter d and a shaft, with the jaw having two parallel flanks surrounding a portion of the shaft, the shaft having a recess, that can be peripheral, in line with the screw in assembled position and each of the flanks having an orifice that the screw passes through, it is characterised in that one of the orifices is of oblong shape. The oblong shape of the orifice makes it possible to prevent the screw from becoming “stuck” between the shaft and the orifice when the shaft is incorrectly positioned, by releasing the screw as soon as the latter enters into contact with another part or an obstacle and as such prevent the transmission of a torque between the two parts to be attached. The recommended torque for the assembly will never be achieved which will make it possible to alert during the assembly cycle of the incorrect positioning of the flank in relation to the other part. The screw will be introduced on the side of the oblong orifice.

According to a first alternative, as each orifice has a centre, the two centres are aligned. The introduction of the screw is as such easier.

According to a second alternative, as each orifice has a centre, the two centres are offset. The offset facilitates the sliding of the screw on the shaft.

According to a particular arrangement of the second alternative, the centre of the oblong is lower than the centre of the other orifice. The offset is more preferably in such a way that the axis of the oblong orifice is lower than the circular orifice, which makes it possible to limit and even not require increasing the height of the flanks of the jaw.

According to an embodiment, the shaft has longitudinal toothings that cooperate with toothings arranged inside the flanks. The shaft and the inside of the flanks are grooved which provides an anti-rotation of the shaft between the flanks.

According to anther embodiment, the shaft has a profile that is complementary with the inside of the flanks. As such the shaft can have angled corners, a polygonal section, the flanks will then have a profile at least partially complementary with that of the shaft in order to provide an anti-rotation.

According to a particular arrangement, a flank is terminated by an end with a recess. This recess is arranged in the plane of the two axes of the orifices and it will facilitate the sliding of the screw on the shaft when the latter is incorrectly positioned.

According to a preferred arrangement, the recess is arranged on the end of the flank facing the oblong orifice. The end of the screw can as such more easily escape towards the top of the flank located across from the oblong orifice.

According to a particular arrangement, the recess has a width greater than the diameter d of the screw. The recess must facilitate the sliding of the screw towards an edge of the flank and its width must make it possible to allow the entire width of said screw to pass. This recess can indifferently have a rounded, oval or square shape.

According to another arrangement, at least one flank is terminated by a chamfered end. The chamfer is arranged on the inside side of the flank and makes it possible to direct the head of the screw towards an edge of the flank, the chamfer therefore has a slope directed towards the inside of the jaw. It shall be considered throughout the description that the top is located on the side of the edges of the flanks constituting the opening of the jaw and the bottom the side opposite said opening.

According to a particular characteristic, the distance between the top of the shaft and the top of the oblong is greater than the diameter d of the screw. This allows the screw to pass over the shaft more easily.

According to another characteristic, the oblong has a height greater than the diameter of the screw. It can for example be greater than or equal to twice its width. The height of the oblong will depend on the width of the jaw the wider it is the less the oblong needs to be high and vice versa, the less the jaw is the more the height of the oblong has to be high, and the thickness of the sheet also has an impact. The oblong orifice can also be carried out by a complementary part.

Other advantages can further appear to those skilled in the art when reading the examples hereinbelow, shown in the annexed figures, given by way of example.

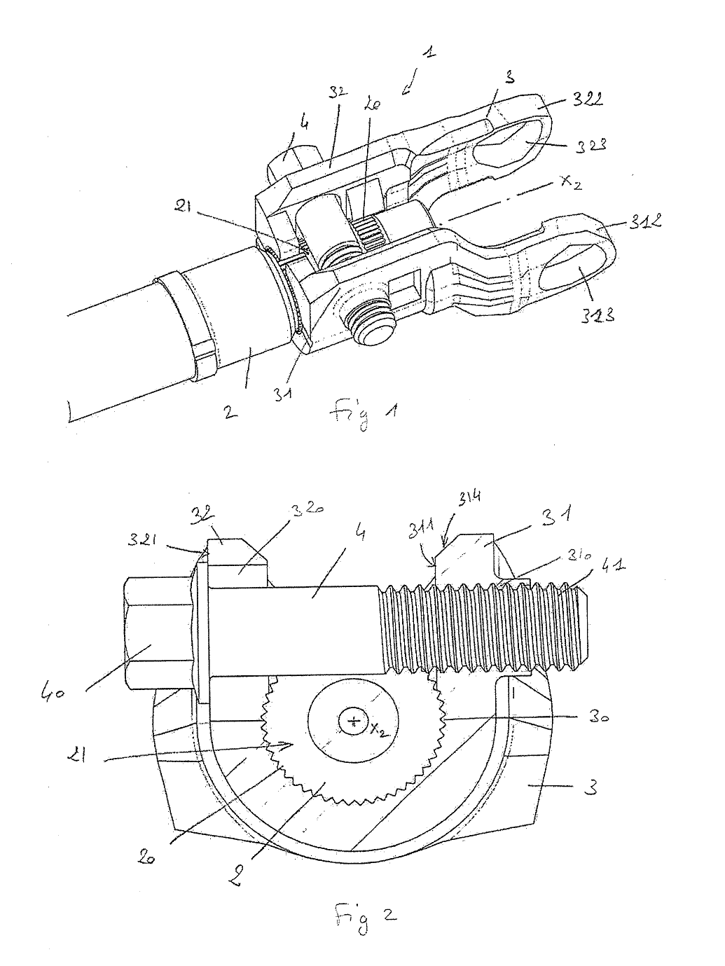

FIG. 1 is a perspective view of a device for fastening according to the invention correctly mounted,

FIG. 2 is a transversal cross-section of the device of FIG. 1,

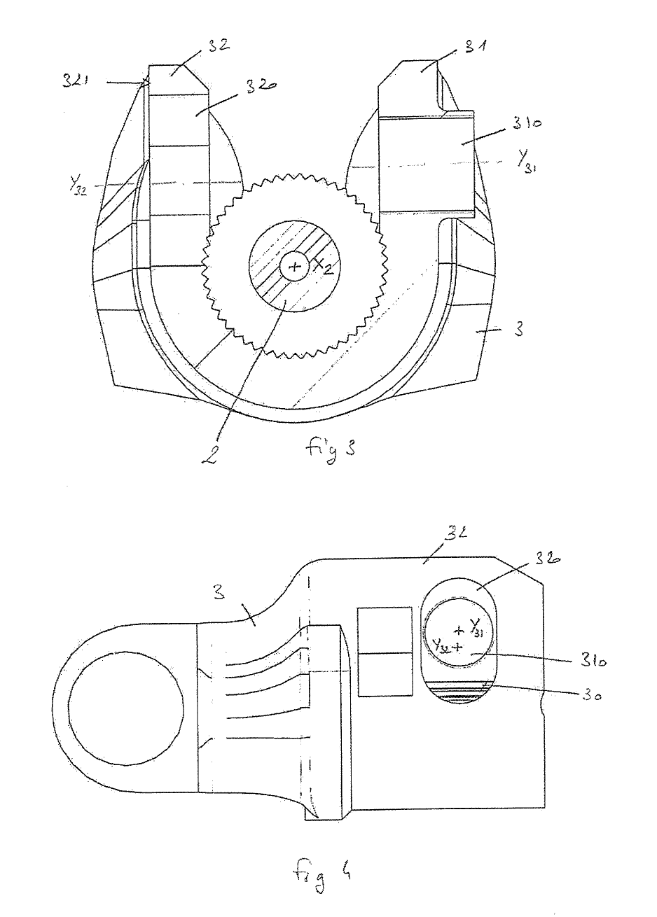

FIG. 3 is a cross-section view of the jaw with the shaft without the screw,

FIG. 4 is a side view of the jaw,

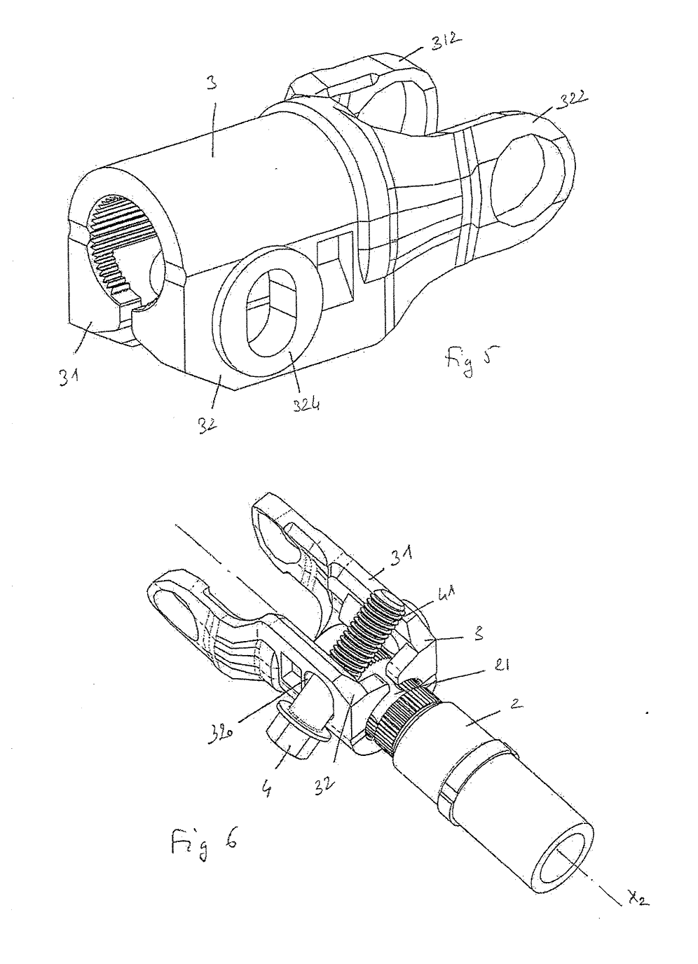

FIG. 5 is a perspective view of the jaw with the added part,

FIG. 6 is a perspective view of the device with a shaft partially engaged in the jaw and an incorrectly arranged screw,

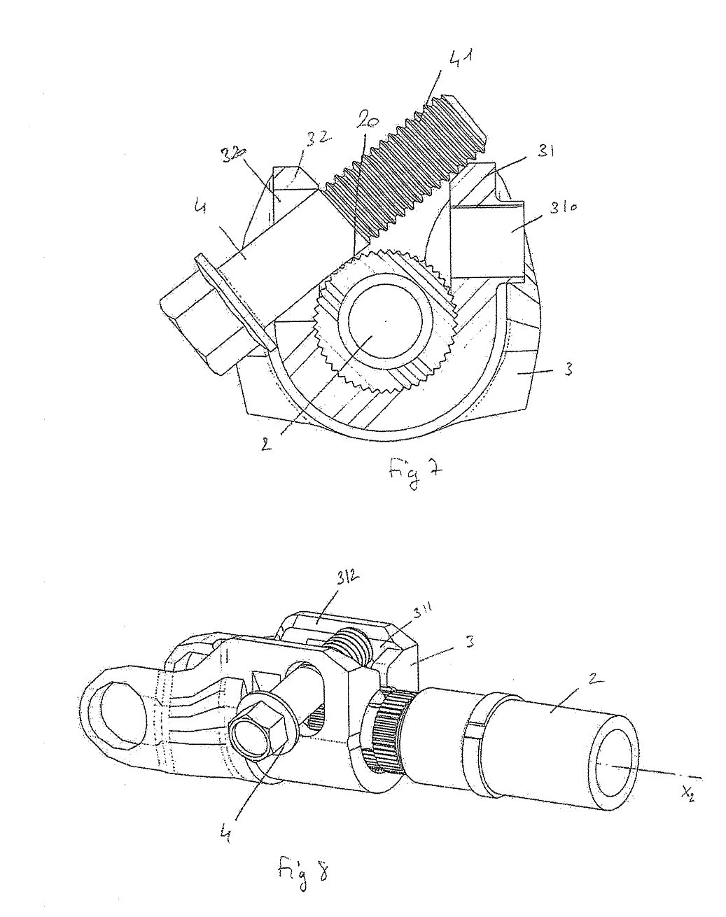

FIG. 7 is a cross-section of FIG. 6,

FIG. 8 is a perspective of the device with the shaft partially engaged and the screw in another position,

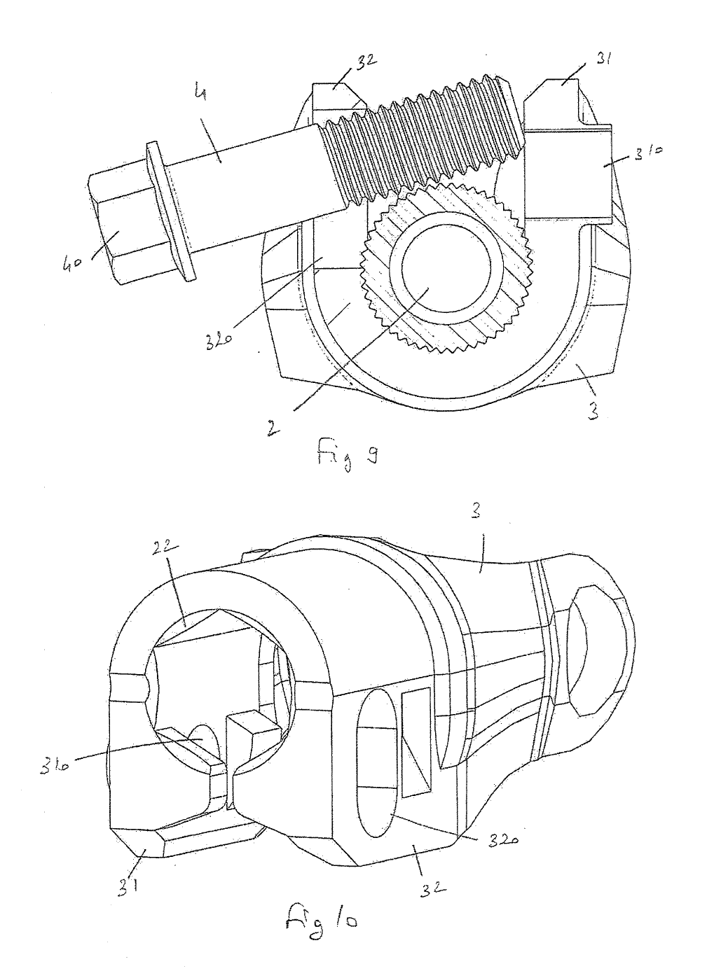

FIG. 9 is a cross-section of FIG. 8,

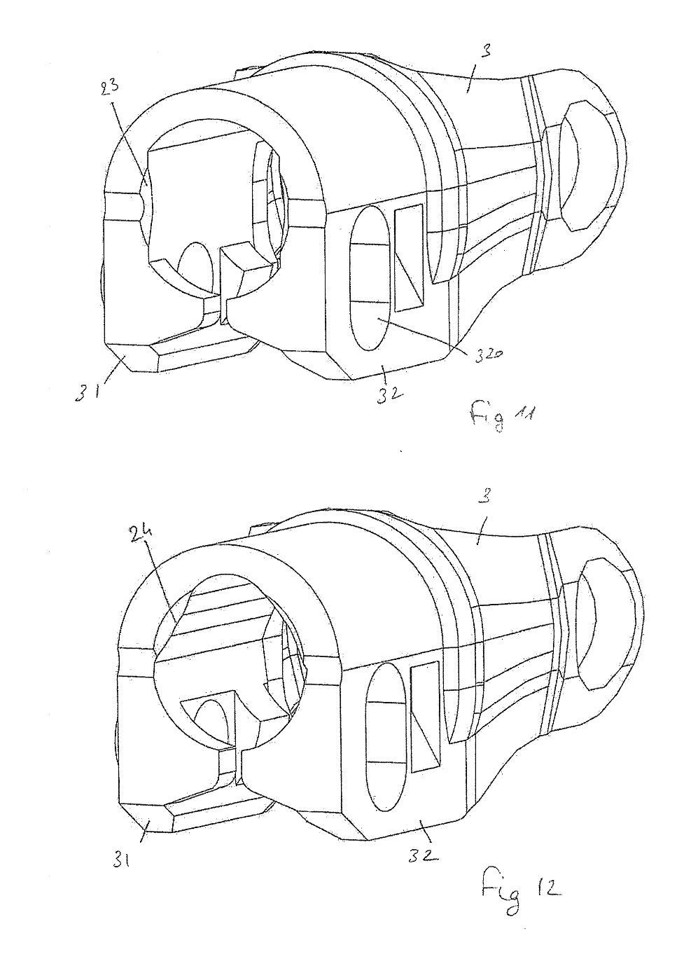

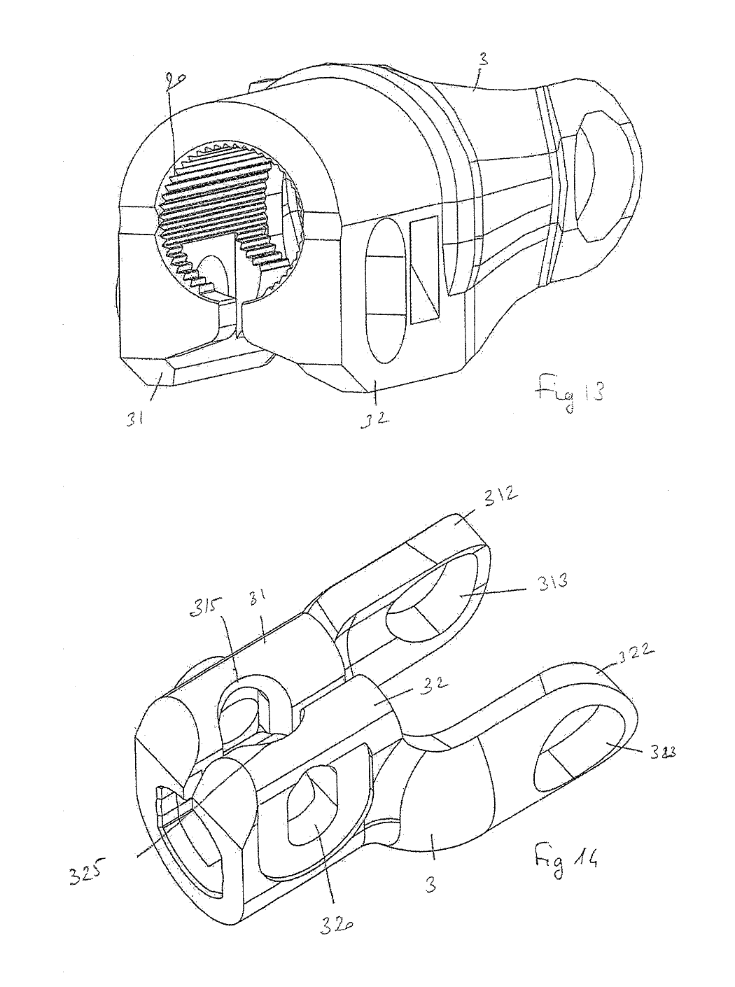

FIGS. 10, 11, 12 and 13 are views of the jaw of the side of the shaft according to different embodiments,

FIGS. 14, 15 and 16 are views of the jaw of the side of the flanks according to different embodiments.

Outside shall refer to what is located on the outside of the jaw and inside what is placed inside the jaw.

Throughout the description the same parts will bear the same references.

The device for fastening 1 comprises a shaft 2, a jaw 3 and a screw 4. The shaft 2 has an axis X₂.

The shaft 2 shown in FIGS. 1 and 2 has grooves 20 over its entire periphery in a portion of the zone intended to be placed in the jaw 3. These grooves 20 cooperate with grooves 30 placed inside the jaw 3. The jaw 3 comprises two flanks 31 and 32 which are each pierced with an orifice 310 and 320. The screw 4 passes through each of the orifices 310 and 320 and comprises a head 40 that abuts against the outer edge 321 of the flank 32 around the orifice 320. The inside of the orifice 310 is threaded in order to make it possible, when the screw 4 is turned to tighten and as such bring the flanks closer together until they exert a pressure on the shaft and as such provide its immobilisation in relation to the jaw. The shaft 2 has a peripheral recess 21 in line with the screw 4 in order to provide an axial fastening of said shaft 2 in the jaw 3.

The flanks 32 and 33 are extended by arms 312 and 322, each of these arms are each pierced with a hole 313 and 323 that cooperate with another element of the steering column (not shown).

In the view in FIG. 4, the axis Y₃₁ of the orifice 310 is offset towards the top of the figure in relation to the axis Y₃₂ of the orifice 320.

The orifice of the flank 32 of FIG. 5 is constituted by an added part 324 with an oblong shape.

An example shall now be described of what happens when the shaft is insufficiently introduced starting with FIGS. 6 and 7.

When the shaft 2 is not correctly positioned, the recess 21 instead of being placed across from the orifices 310 and 320 is offset to one side or the other, the screw 4 is introduced into the orifice 320 but cannot remain in the extension of the two orifices 310 and 320, i.e. perpendicular to the outer edge 321 of the flank 32. The screw 4 is then inclined pressing on the shaft 2, here on the grooves 20, and as the orifice 320 is oblong the end of the screw 4 will slide on the shaft 4 until it exits the jaw 3 above the flank 31. The threaded portion 41 of the screw no longer has any support point and if it is attempted to apply a torque to the screw 4 the latter will rotate idly, and it will be seen that the connection is not carried out. Therefore there is no risk of allowing a poorly mounted part to pass. In order to facilitate the sliding of the screw 4 on the flank 31, a chamfered portion 314 can be provided at the end of said flank 31. This chamfered portion 314 is placed inside the flank 31 in the extension of the inner wall 311.

In the example shown in FIGS. 8 and 9, the shaft 2 is also incorrectly positioned and the screw 4 also slides on the grooves 20 of the shaft 2 and arrives abutting on the inner wall 311 of the flank 310. In this case, the head 40 of the screw 4 will be raised in the oblong orifice 320, and said screw 4 will rotate idly and will not be able to take tightening torque, and it will be seen that the connection is here too not carried out.

A recess 315 and 325 is arranged at the end of each flank 31, 32 of FIG. 14. The recess 315 arranged across from the oblong orifice 320 facilitates the exiting of the screw 4 from the jaw 3 when this screw 4 is incorrectly positioned. The recesses 315 and 325 here are of a rounded shape seen from above.

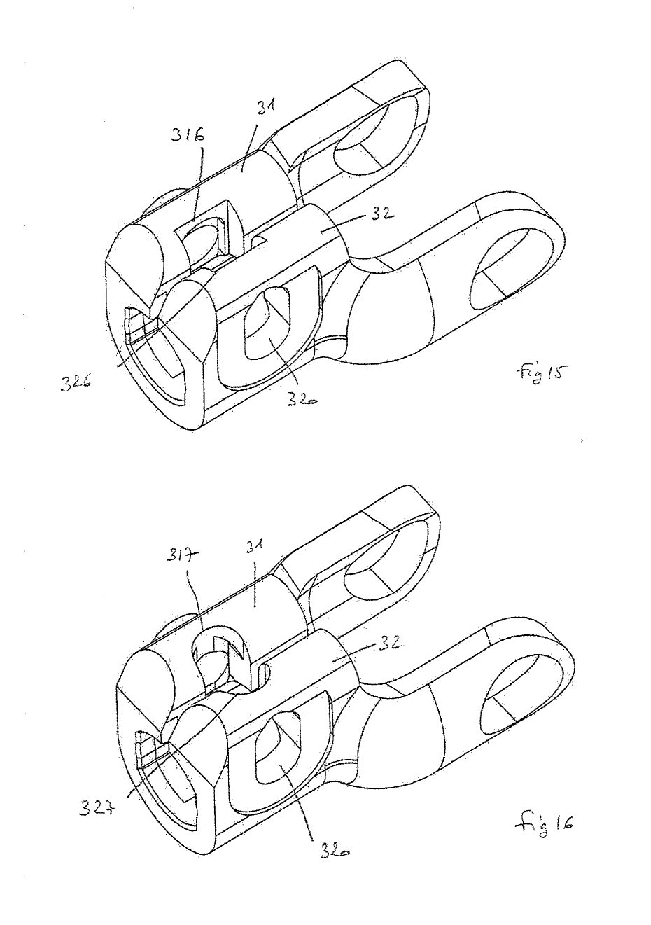

In FIG. 15, the recesses 316 and 326 are of square shape while in FIG. 16, the recesses 317 and 327 are of oval shape.

These recesses 315, 325, 316, 326, 317 and 327 are more preferably of a dimension greater than the diameter of the screw 4.

1. Device for fastening comprising a jaw, a screw with a diameter d and a shaft, the jaw having two parallel flanks surrounding a portion of the shaft, the shaft having a recess in line with the screw in assembled position and with each of the flanks having an orifice that the screw passes through, characterised in that one of the orifices is of oblong shape.

2. Device for fastening according to claim 1 characterised in that as each orifice has a centre, the two centres are aligned.

3. Device for fastening according to claim 1 characterised in that as each orifice has a centre, the two centres are offset.

4. Device for fastening as claimed in claim 1 characterised in that the centre of the oblong orifice is lower than the centre of the other orifice.

5. Device for fastening according to claim 1 characterised in that the shaft has longitudinal toothings cooperating with toothings arranged inside the flanks.

6. Device for fastening according to claim 1 characterised in that the shaft has a profile that is complementary with he inside of the flanks.

7. Device for fastening according to claim 1 characterised in that at least one flank is terminated by an end with a recess.

8. Device for fastening as claimed in claim 1 characterised in that the recess is arranged on the end of the flank facing the oblong orifice.

9. Device for fastening as claimed in claim 1 characterised in that the recess has a width greater than the diameter d of the screw.

10. Device for fastening according to claim 1 characterised in that at least one flank is terminated by a chamfered end.

11. Device for fastening according to claim 1 characterised in that the distance between the top of the shaft and the top of the oblong orifice is greater than the diameter d of the screw.

12. Device for fastening according to claim 1 characterised in that the oblong orifice has a height greater than the diameter of the screw.
